(19) United States
(12) Patent Application Publication
(10) Pub. No.: US 2026/0001614 A1
(43) Pub. Date: Jan. 1, 2026

(54) ADJUSTABLE MOTORCYCLE HANDLEBAR

(71) Applicant: Richard Valois, Lansdale, PA (US)

(72) Inventor: Richard Valois, Lansdale, PA (US)

(21) Appl. No.: 19/251,929

(22) Filed: Jun. 27, 2025

Related U.S. Application Data
(60) Provisional application No. 63/665,643, filed on Jun. 28, 2024.

(51) Int. Cl. B62K 21/16; B62K 21/14

(52) U.S. Cl. CPC B62K 21/16; B62K 21/14

(57) ABSTRACT

An adjustable handlebar system for steerable vehicles is disclosed, enabling selective angular positioning between two handlebar segments via a mechanically interlocking interface. The system includes complementary gear teeth machined into mating segments and a central locking fastener that secures the selected angle under operational load. This adjustability enhances ergonomic alignment, reduces rider fatigue, and improves handling precision. The system is modular and applicable to motorcycles, bicycles, ATVs, fitness equipment, and other steerable devices requiring user-specific control customization.

### CROSS REFERENCE TO RELATED APPLICATION

This application claims the benefit of priority of U.S. provisional application No. 63/665,643, filed 28 Jun. 2024, the contents of which are herein incorporated by reference.

### BACKGROUND OF THE SUBJECT DISCLOSURE

The present subject disclosure relates to motorcycle steering controls and, more particularly, to an adjustable motorcycle handlebar system that enables an ergonomic, selective angular adjustment of the steering controls to reduce rider fatigue and improve control.

Existing motorcycle handlebars typically employ a fixed, linear configuration extending horizontally from a clip-on mount or fastener mounted to a distal end of a handle-fork. This rigid design forces riders into non-ergonomic wrist, arm, and shoulder positions, contributing to muscular strain, fatigue, and discomfort-particularly during prolonged rides or aggressive maneuvering. The fixed-angle geometry further limits rider control and handling precision when navigating tight curves or uneven surfaces. Consequently, riders experience compromised comfort, performance, and safety due to the inflexibility of conventional handlebar systems.

Other handlebar systems in this field rely on a rigid, unitary design that lacks the capability for post-installation angular adjustment. This limitation results in rider discomfort over time, as users are constrained to a singular hand and arm position irrespective of body type, riding style, or road conditions. Such systems inherently sacrifice ergonomic adaptability and contribute to rider fatigue and reduced maneuverability.

The absence of built-in adjustability in existing systems forces riders into unnatural and non-variable wrist alignments, particularly under dynamic conditions such as cornering, off-road traversal, or prolonged highway use. The fixed geometry leads to increased musculoskeletal strain and diminished precision in control inputs, impairing overall riding performance and increasing the risk of fatigue-induced errors.

As can be seen, there is a need for an adjustable motorcycle handlebar system that enables an ergonomic, selective angular adjustment of the steering controls to reduce rider fatigue and improve control.

### SUMMARY OF THE SUBJECT DISCLOSURE

This subject disclosure improves existing systems by introducing a mechanically interlocking adjustment interface between two handlebar segments.

The use of precision-machined gear teeth and a locking screw enables controlled, incremental angle customization. This modular adjustability accommodates rider-specific ergonomic needs while maintaining structural integrity under load, thereby enhancing both rider comfort and operational safety.

The mechanically adjustable handlebar system embodied by the subject disclosure may be composed of two interlocking segments with integrated gear teeth and a central fastening mechanism. This configuration enables angular adjustment of the upper handlebar segment relative to the lower, allowing the rider to establish a preferred ergonomic orientation. Once set, the position is secured via a threaded fastener that fixes the gear teeth in place, thereby preventing slippage or rotation during use. The system affords an adjustability of motorcycle steering controls that significantly reduces joint strain, improves rider posture, and enhances handling control without compromising structural integrity.

Unlike conventional handlebars that employ a fixed, non-adjustable structure, the subject disclosure integrates an angular adjustment mechanism directly into the handlebar assembly using interlocking gear teeth and a locking fastener. This allows for secure, repeatable ergonomic customization by the rider, enhancing comfort and control. The design combines structural robustness with functional flexibility, providing benefits not available in current commercially available handlebar configurations.

In one aspect of the present subject disclosure, an adjustable steering control system provides the following: a first steering control segment configured to be anchored to a steerable object; a second steering control segment operatively associated with the first steering control segment by way of an angular adjustment interface; and the angular adjustment interface configured so that an angular orientation between said first and second steering control segments is selectable about a pivot axis of the angular adjustment interface.

In another aspect of the present subject disclosure, the adjustable steering control system further provides the following: wherein the angular adjustment interface comprises two gear heads, one of the two gear heads fixed to said first and second steering control segments, respectively, wherein each gear head provides a fastener slot that, when aligned with the other fastener slot, defines the pivot axis, wherein each gear head comprises a circular array of gear teeth dimensioned and shaped to removably interlock with the other circular array of gear teeth so that the angular orientation between said first and second steering control segments is selectable about the pivot axis, wherein each circular array of gear teeth is concentrically disposed relative to the pivot axis, wherein each fastener slot communicates an exterior surface of the respective gear head to an inner face thereof, wherein the inner face supports the respective circular array of gear teeth; and further providing a clamp to removably anchor the first steer control segment to the steerable object, wherein the steerable object comprises a motorcycle.

In an aspect of the subject disclosure, an adjustable steering control system includes the following: a first steering control segment configured to be anchored to a steerable object; a second steering control segment operatively associated with the first steering control segment by way of an angular adjustment interface; wherein the angular adjustment interface enables selective adjustment of an angular orientation between said first and second steering control segments about a pivot axis; and a fastener configured to secure the angular orientation in a fixed position, wherein the angular adjustment interface comprises a pair of gear heads, one fixed to each of the first and second steering control segments, each gear head including a circular array of gear teeth, wherein the gear teeth of each gear head are dimensioned and shaped to removably interlock with each other and are concentrically arranged about the pivot axis, wherein the fastener comprises a threaded screw configured to pass through aligned fastener slots in both gear heads and engage with a complementary locking feature; further providing a clamp configured to removably anchor the first steering control segment to a handle-fork of a motorcycle, wherein the steerable object includes a motorcycle, bicycle, scooter, all-terrain vehicle or fitness equipment; further providing a secondary locking mechanism or safety pin to provide redundant fixation of the selected angular orientation; further providing vibration-dampening material positioned between the first and second steering control segments, and wherein at least one of the steering control segments includes etched indexing markers to aid in repeatable angle selection.

In another aspect of the subject disclosure, a method of adjusting a handlebar angle of a steerable object, the method providing: (a) loosening a fastener securing a first steering control segment to a second steering control segment at an angular adjustment interface; (b) rotating the second steering control segment about a pivot axis to a desired angular orientation; and (c) tightening the fastener to lock the angular orientation in place.

In yet another aspect of the subject disclosure, a method of manufacturing an adjustable handlebar system includes the following: (a) machining first and second tubular segments; (b) cutting concentric interlocking gear teeth on mating surfaces of said segments; (c) forming aligned fastener apertures through said segments along a common axis; and (d) inserting and securing a fastener to lock the angular position.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure.

FIG. 2 is a perspective view of an exemplary embodiment of the subject disclosure.

FIG. 3 is an exploded perspective view of an exemplary embodiment of the subject disclosure.

FIG. 4 is an exploded perspective view of an exemplary embodiment of the subject disclosure.

FIG. 5 is a top plan view of an exemplary embodiment of the subject disclosure.

FIG. 6 is a section view of an exemplary embodiment of the subject disclosure, taken along line 6-6 in FIG. 5.

FIG. 7 is a perspective view of an exemplary embodiment of the subject disclosure, illustrating selectively positioning between the first and second steering control segments.

FIG. 8 is a perspective view of an exemplary embodiment of the subject disclosure, illustrating an exemplary installed condition.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

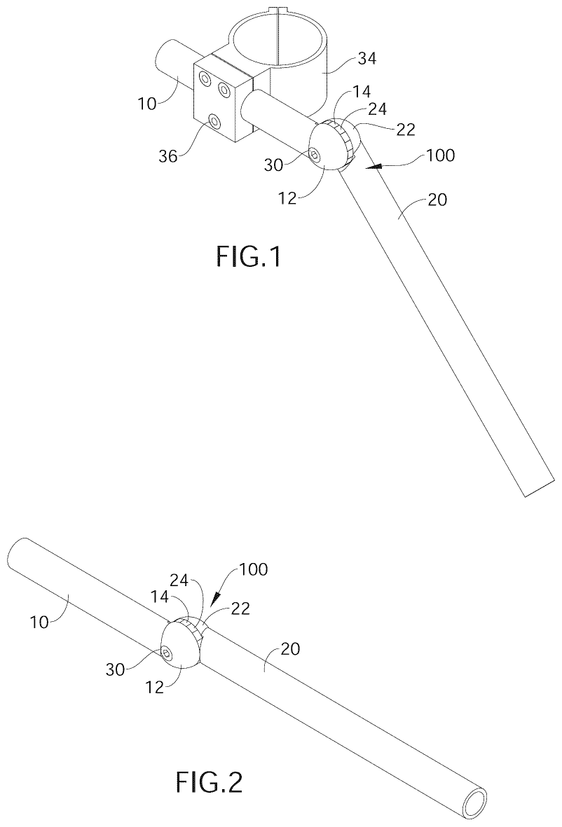

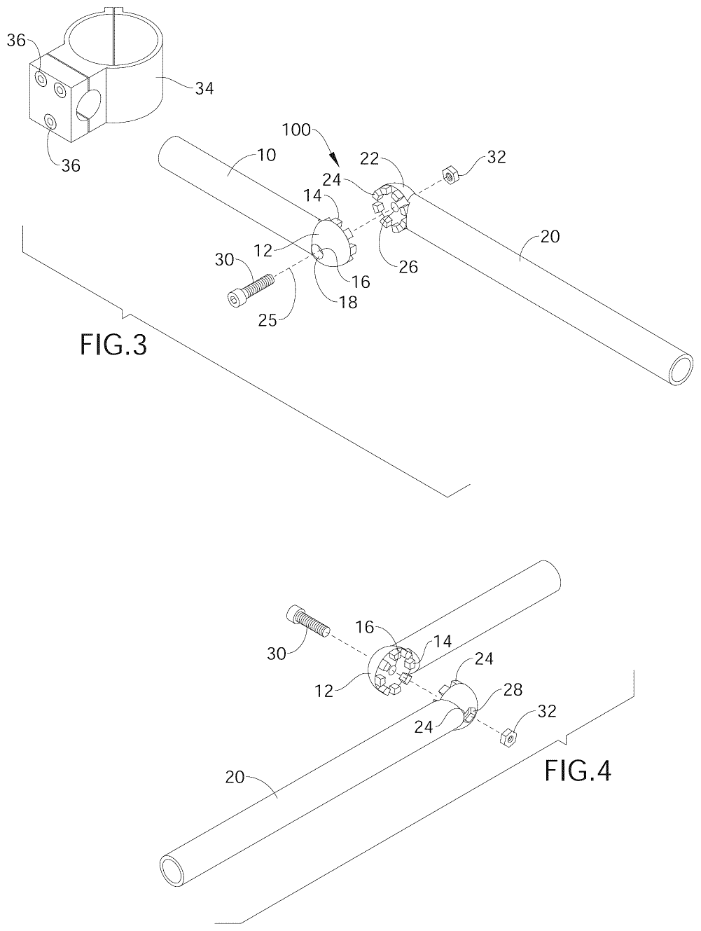

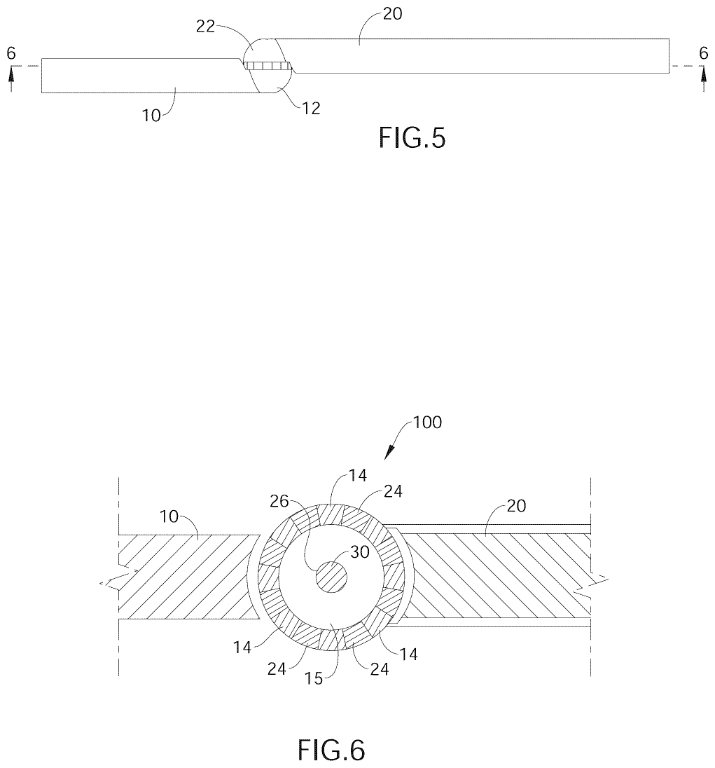

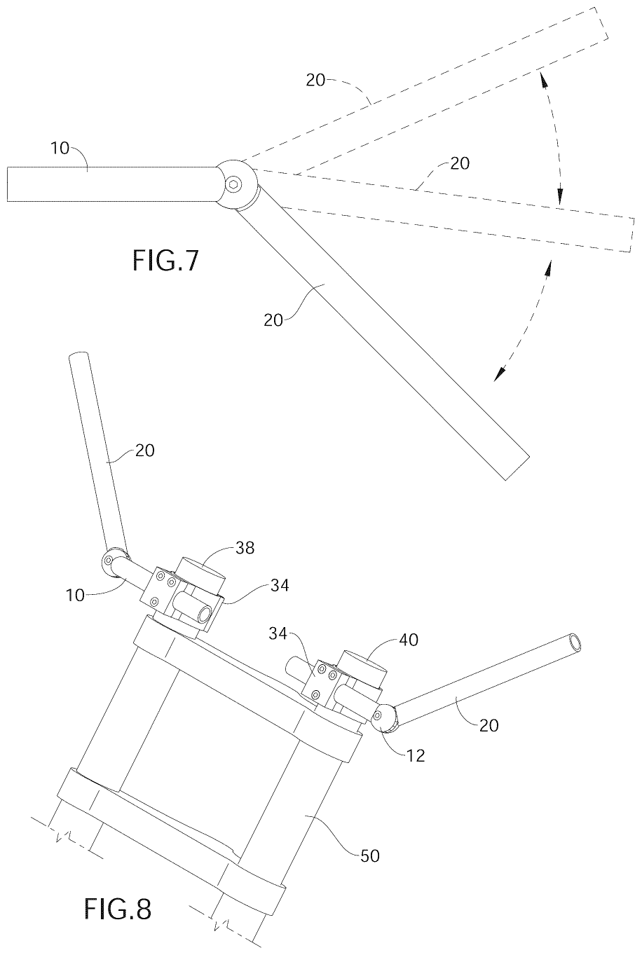

Referring to FIGS. 1 through 8, the subject disclosure provides a mechanically interlocking adjustment interface 100 operatively associated with two steering control segments for a motorcycle 50 so that the angular orientation of a first steering control segment 10 relative to a second steering control segment 20 is selectively adjustable.

The second steering control segment 20 may be any structure conducive to providing a human user manual steering control of a motorcycle's steering mechanism, including tubular components and the like. The first steering control segment 10, even though consistently shown in the appended figures as tubular, need not be as long as it enables operative association of the second steering control segment 20 and the mechanically interlocking adjustment interface 100 on one end and an adjustable locked engagement to the motorcycle 50, typically by way of first and second handle-forks 38 and 40 thereof.

The mechanically interlocking adjustment interface 100 includes two interfacing gear heads, a first gear head 12 and a second gear head 22, at the distal end of the first steering control segment 10 and at the proximal end of the second steering control segment 20, respectively. Each gear head 12, 22 has a circular array of gear teeth 14, 24, respectively, wherein the gear teeth are geared so that the two gear heads 12, 22 can interface and thus interlock at one of a plurality of an angular orientations relative to each other, thereby selectively establishing one of a plurality of relative angular orientations of the steering control segments 10, 20.

Each gear head 12, 22 has a fastener slot 16, 26, respectively, each of which may have a countersunk entry 18, 28, respectively. Each fastener slot communicates an outer face of the gear head to an inner face 15 thereof, where the circular array of gear teeth is disposed, and wherein along fastener slot is centrally location along said inner face 15 so that each gear tooth of the circular array of gear teeth is approximately equidistantly spaced apart from the fastener slot. The pathway defined by the aligned fastener slots 16 and 26, during interfacing, defines a pivot axis 25 about which the two gear heads 12, 22 can be angularly adjusted relative to each other.

A fastener 30 is dimensioned and adapted to pass through both fastener slots 16 and 26 so as to form a locked engagement between the two respective gear heads 12 and 22 relative to each other. The fastener 30 may be, but not necessarily is, a threaded screw. The fastener 30 may be complemented with a locking fastener 32, such as a nut, to further secure the locked engagement.

The subject disclosure also contemplates a clamp 34 that can be operatively associated with a proximal end of the first steering control segment 10. The clamp 34 is dimensioned and adapted to removably attach to a handle-fork 38/40 of a motorcycle 50. The clamp 34 has a fastener set 36 to form the secure attachment between the handle-fork 38/40 and the first steering control segment 10.

The subject disclosure comprises a two-part handlebar assembly, including the first steering control segment 10 configured for insertion into a standard motorcycle clip-on and the second steering control segment 20 configured to couple with the first steering control segment 10. Both steering control segments are equipped at one end with complementary interlocking gear teeth, which permit controlled rotational adjustment about a pivot axis. Once the desired angular orientation is achieved, the fastener 30 is inserted through precisely aligned, upon interfacing of the complementary gear teeth 14 and 24, threaded apertures, fastener slots 16, 26 traversing both handlebar segments. Tightening fastener 30 fixes the interlocked gear teeth in place, securing the assembly against relative movement during operation. This configuration provides a rigid, yet adjustable ergonomic handlebar system designed to withstand the mechanical stresses of motorcycle use.

The subject disclosure operates as an integrated mechanical assembly designed to enable angular adjustment of a motorcycle handlebar for ergonomic optimization. Each component serves a distinct function while contributing to the secure and adjustable operation of the system. The first control steering segment 10 functions as the base structural element and is configured for insertion into a conventional motorcycle clip-on, serving as the fixed anchor point for the system. It includes one half of the interlocking gear teeth and a portion of the through hole for alignment and fastening. The upper second control steering segment 20 mates with the lower first control steering segment 10 and contains a complementary set of interlocking gear teeth and the opposing portion of the through hole. This segment is rotatable relative to the first control steering segment 10 prior to fixation and is intended to be grasped by the rider.

The interlocking gear teeth may be precision-machined structures located on the mating surfaces of the control steering segments 10 and 20. These teeth allow for controlled rotational adjustment between the two segments in discrete angular increments. Once meshed, they resist torsional slippage under load. The threaded aperture/fastener slots 16 and 26 are bores that pass axially through the gear heads 12 and 22, respectively, at the interlocking interface. It is internally threaded on one end to receive the fastener 30 and is used to secure the desired angular configuration.

The fastening 30 may be a mechanical fastener inserted through the fastener slots, so that when torqued to specification a clamping force is applied, thereby maintaining the interlocked gear engagement and preventing unintentional rotation during dynamic operation. The clamp 34 or other motorcycle clip-on, may be a mounting bracket that receives and secures the first steering control segment 10 to the motorcycle chassis, ensuring the overall assembly is rigidly fixed to the front forks.

The user initiates the adjustment process by aligning the steering control segments such that the interlocking gear teeth engage at the desired angular orientation. Once aligned, the fastening screw is inserted through the threaded aperture and torqued until the two handlebar segments are secured. The gear teeth prevent rotational movement, while the screw provides axial clamping force that fixes the position. Once assembled, the rider experiences a handlebar setup tailored to their ergonomic preference, resulting in reduced physical strain and enhanced control. The system's modular nature ensures repeatable, stable adjustments while preserving the structural integrity required for motorcycle operation.

A method of making the subject disclosure may include a skilled machinist fabricating the adjustable motorcycle handlebar using standard manufacturing techniques and durable materials such as 6061-T6 aluminum or stainless steel. From there, the manufacturer may cut, and shape segments using a CNC lathe or mill to cut two handlebar pieces, shaping their mating ends for gear tooth engagement. The fabrication of the gear teeth may employ the use of a gear hobbing or CNC milling machine to cut interlocking radial gear teeth into the mating faces of both handlebar pieces, allowing for angular adjustment. Then the manufacturer may drill and thread the fastener hole, align both pieces in the neutral position, drill an axial hole through the gear face, and tap one side to accept a screw. Continuing, the manufacturer may select or fabricate a screw of appropriate length and tensile strength to lock both segments together through the threaded bore. Finish components may include deburr edges and optionally apply anodizing or powder coating for durability and corrosion resistance and assembly, where alignment the gear teeth to an initial desired angle is performed, and then the manufacturer may insert and tighten the screw to lock the position. Finally, mount the clamp per manufacturer specifications so that the overall process yields an adjustable, durable, and ergonomic handlebar assembly ready for installation.

Optional Elements include the following: Surface Coatings, Anodizing or powder coating improves corrosion resistance and appearance. Ergonomic Grips: Can reduce vibration and increase rider comfort. Safety Pin or Redundant Locking Feature: May be used to prevent accidental loosening. Potential Enhancements Quick-Release Locking Mechanism: Enables fast angle changes without tools, beneficial for racing or multi-rider use. Vibration Dampening Inserts: Reduces fatigue by minimizing vibration transfer from the motorcycle frame to the rider's hands. Indexing Angle Markers: Precision-etched markings help riders make consistent, repeatable angle adjustments. Dual Fastener Design: Adds a second screw or locking bolt to improve load distribution and increase safety margin. Ulti-Tooth Engagement System: Provides finer adjustment increments and stronger torsional lock between handlebar segments.

The subject disclosure functional outcome of providing an adjustable, secure handlebar angle can be preserved through several alternative configurations: Central Hub Variant: Instead of a two-piece linear connection, a central rotational hub with radial arms could provide angle adjustment using the same gear or detent principle. Ratcheting Mechanism: Replace gear teeth with a ratchet-and-pawl system to allow preset angular stops with one-directional locking. Cam-Lock or Lever Clamp: Substitute the screw with a cam-locking or lever-clamping mechanism for tool-free angle fixation. Interlocking Grooves: Instead of gear teeth, use alternating grooves or splines to create friction-fit engagement with angular indexing. Magnetic Locking Interface: Use rare-earth magnets embedded in mating faces to create a semi-permanent lock, with optional mechanical reinforcement. Modular Segment Design: Utilize snap-fit or keyed interchangeable segments to enable fast reconfiguration or replacement of bar components. Telescopic or Sliding Joint: Replace fixed-length segments with sliding rails and detent pins to allow length and angle adjustability simultaneously. Material Substitution: Replace metal with high-strength composites or polymers without affecting the functional mechanism, provided tolerances and structural integrity are maintained. These interchangeable configurations still achieve the core function-ergonomic handlebar angle adjustment and secure fixation.

A user would use the subject disclosure by following a sequence of installation and adjustment steps to achieve a personalized, ergonomic handlebar position, thereby reducing fatigue and improving riding control. The process is as follows: 1. Initial Installation, i.e., inserting the lower handlebar segment into the motorcycle's existing clip-on bracket and secure it according to the manufacturer's torque specifications or retention method (e.g., clamping bolt, compression sleeve, or safety pin). Ensure the segment is firmly mounted to the front forks and properly aligned with the motorcycle's steering geometry. 2. Angle Adjustment Preparation Position the upper handlebar segment so that its interlocking gear teeth align with the corresponding teeth on the first steering control segment. Rotate the second steering control segment to the desired angular orientation, which may range from level to a downward tilt depending on rider preference. 3. Locking the Configuration Insert the fastening screw through the threaded hole that spans both handlebar segments. Tighten the screw using a torque wrench to a manufacturer-defined specification to secure the gear teeth engagement. This ensures that the adjusted angle is locked and will not shift under vibration or rider input. 4. Ergonomic Testing with the handlebar now fixed in place, the rider mounts the motorcycle and tests the handlebar position in seated posture. Assess wrist, arm, and shoulder alignment to ensure that the position reduces strain and supports a natural grip angle. 5. Re-adjustment (if necessary) if discomfort or strain is detected, loosen the screw, slightly rotate the second steering control segment to a revised angle, and re-tighten. Repeat until optimal ergonomic alignment is achieved. 6. Operational use once configured, the rider operates the motorcycle as usual. The adjusted handlebar angle provides improved ergonomics, reducing fatigue during long rides or aggressive maneuvers, and improving control and ride. This sequence ensures the rider can configure and lock the handlebars into a position that addresses the discomfort and control limitations posed by traditional fixed-angle handlebar designs.

Even though throughout the disclosure the term “motorcycle” is repeatedly used, it is to be understood that the subject disclosure may be applicable to any passenger personal vehicle steered by a handlebar, including bicycles, all-terrain vehicles, one-wheeled, three-wheeled, four-wheeled vehicles of any type. More specifically, beyond motorcycles, the core adjustable handle mechanism-comprised of interlocking segments with angular adjustment and secure fixation—can be applied across various industries where ergonomic variability, control precision, or user-specific configuration is beneficial. 1. Bicycles The system can be adapted for road, mountain, or stationary bicycles, allowing riders to adjust handlebar angles for comfort or performance, especially useful for individuals with joint limitations or endurance needs. 2. Medical Equipment Wheelchairs, hospital beds, and rehabilitation devices can use the mechanism for adjustable handrails or caregiver handles, enabling customization based on patient mobility or caregiver ergonomics. 3. Fitness Equipment Stationary bikes, treadmills, and elliptical machines can integrate the adjustable interface into grip positions or console mounts, improving posture alignment and reducing repetitive strain injuries during prolonged workouts. 4. Construction Tools Hand-operated equipment such as jackhammers, drills, or grinders can incorporate the subject disclosure to enable adjustable handle positions, increasing operator control and reducing fatigue in variable job site conditions. 5. Gaming and Simulation Control Racing and flight simulators can use the system for customizable control stick angles, enhancing realism and comfort during extended gaming or training sessions. 6. Robotic Manipulators The adjustable joint can serve as a man-machine interface in robotic arms, allowing fine-tuned positioning of control handles or joysticks to improve accuracy and operator comfort in sensitive or repetitive tasks. By applying the core subject disclosure-angular adjustment with secure locking—to these alternative domains, it maintains its functional identity while delivering ergonomic, performance, or safety benefits tailored to specific field demands.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. An adjustable steering control system, the system comprising:
a first steering control segment configured to be anchored to a steerable object;
a second steering control segment operatively associated with the first steering control segment by way of an angular adjustment interface;
wherein the angular adjustment interface enables selective adjustment of an angular orientation between said first and second steering control segments about a pivot axis; and
a fastener configured to secure the angular orientation in a fixed position.

2. The system of claim 1, wherein the angular adjustment interface comprises a pair of gear heads, one fixed to each of the first and second steering control segments, each gear head including a circular array of gear teeth.

3. The system of claim 2, wherein the gear teeth of each gear head are dimensioned and shaped to removably interlock with each other and are concentrically arranged about the pivot axis.

4. The system of claim 3, wherein the fastener comprises a threaded screw configured to pass through aligned fastener slots in both gear heads and engage with a complementary locking feature.

5. The system of claim 4, further comprising a clamp configured to removably anchor the first steering control segment to a handle-fork of a motorcycle.

6. The system of claim 1, wherein the steerable object comprises a motorcycle, bicycle, scooter, all-terrain vehicle or fitness equipment.

7. The system of claim 1, further comprising a secondary locking mechanism or safety pin to provide redundant fixation of the selected angular orientation.

8. The system of claim 1, further comprising vibration-dampening material positioned between the first and second steering control segments.

9. The system of claim 1, wherein at least one of the steering control segments includes etched indexing markers to aid in repeatable angle selection.

10. A method of adjusting a handlebar angle of a steerable object, comprising:
(a) loosening a fastener securing a first steering control segment to a second steering control segment at an angular adjustment interface;
(b) rotating the second steering control segment about a pivot axis to a desired angular orientation; and
(c) tightening the fastener to lock the angular orientation in place.

11. A method of manufacturing an adjustable handlebar system, comprising:
(a) machining first and second tubular segments;
(b) cutting concentric interlocking gear teeth on mating surfaces of said segments;
(c) forming aligned fastener apertures through said segments along a common axis; and
(d) inserting and securing a fastener to lock the angular position.
